(19) United States
(12) Patent Application Publication
(10) Pub. No.: US 2013/0235305 A1
(43) Pub. Date: Sep. 12, 2013

(54) OPTICAL DEVICE, DISPLAY APPARATUS AND ELECTRONIC APPARATUS

(71) Applicant: JAPAN DISPLAY WEST, INC., Aichi-Ken (JP)

(72) Inventors: Daisuke Takama, Kanagawa (JP); Takeo Koito, Kanagawa (JP); Tsuyoshi Ohyama, Tokyo (JP)

(73) Assignee: JAPAN DISPLAY WEST, INC., Aichi-Ken (JP)

(21) Appl. No.: 13/768,459

(22) Filed: Feb. 15, 2013

(30) Foreign Application Priority Data
Mar. 8, 2012 (JP) 2012-051827

(51) Int. Cl. G02F 1/1335

(52) U.S. Cl. CPC G02F 1/133528
USPC 349/96

(57) ABSTRACT

An optical device includes: first electrodes; a second electrode arranged so as to face the first electrodes; a liquid crystal layer arranged between the first electrodes and the second electrode, producing a lens effect in accordance with a voltage to be applied to the first electrodes and the second electrode; and a polarizing plate arranged on an outermost surface.

### FIELD

The present disclosure relates to an optical device, a display apparatus and an electronic apparatus.

### BACKGROUND

When an electric field distribution in a liquid crystal layer is controlled by applying a voltage between electrodes arranged so as to face each other with the liquid crystal layer sandwiched therebetween, liquid crystal molecules included in the liquid crystal layer are aligned in accordance with the electric field distribution. When an alignment state is changed, a refractive index with respect to incident light in the liquid crystal layer is changed as the liquid crystal molecules have refractive index anisotropy. As the electric field distribution applied to the liquid crystal layer is controlled by controlling the voltage to be applied between electrodes so as to obtain a refractive index distribution in which a lens effect is produced by utilizing the above phenomenon, the device can be used as a liquid crystal lens. A 3D display apparatus using such liquid crystal lens is disclosed in, for example, JP-A-2007-213081 (Patent Document 1).

### SUMMARY

The above liquid crystal lens produces the lens effect with respect to light having a particular polarization direction, however, the liquid crystal lens does not produce the lens effect with respect to light having different polarization directions. Accordingly, light polarized so as to have the particular polarization direction is incident on the liquid crystal lens. However, the lens effect is not produced with respect to certain light due to, for example, depolarization of incident light in spacer portions, an alignment defect of liquid crystal on electrodes and so on. In such case, unnecessary light is included in light emitted from the liquid crystal lens.

In view of the above, it is desirable to reduce unnecessary light included in light emitted from the liquid crystal lens.

An embodiment of the present disclosure is directed to an optical device including first electrodes, a second electrode arranged so as to face the first electrodes, a liquid crystal layer arranged between the first electrodes and the second electrode, producing a lens effect in accordance with a voltage to be applied to the first electrodes and the second electrode, and a polarizing plate arranged on an outermost surface.

Another embodiment of the present disclosure is directed to a display apparatus including a display unit emitting image light polarized in a particular polarization direction, a liquid crystal lens arranged so as to face the display unit and forming images of the image light emitted by the display unit in plural viewpoints, and a polarizing plate arranged on the liquid crystal lens.

Still another embodiment of the present disclosure is directed to an electronic apparatus including a display unit emitting image light polarized in a particular polarization direction, a liquid crystal lens arranged so as to face the display unit and forming images of the image light emitted by the display unit in plural viewpoints, and a polarizing plate arranged on the liquid crystal lens.

As described above, according to the embodiments of the present disclosure, it is possible to reduce unnecessary light included in light emitted from the liquid crystal lens.

### BRIEF DESCRIPTION OF THE DRAWINGS

FIG. 1 is an explanatory view showing a structure of an optical device according to an embodiment of the present disclosure;

FIG. 2 is an explanatory view showing a phenomenon occurring in a liquid crystal lens;

FIG. 3 is an explanatory view showing a modification example of the structure of the optical device according to the embodiment of the present disclosure;

FIG. 4 is an explanatory view showing a structure of a display apparatus using the optical device according to the embodiment;

FIG. 5 is an explanatory view showing an example of an appearance of a lenticular lens and a screen structure;

FIG. 6 is an explanatory view showing the principle of the lenticular lens;

FIG. 7 is a block diagram showing a configuration example of an electronic apparatus using the display apparatus including the optical device according to the embodiment of the present disclosure;

FIG. 8 is an explanatory view showing an example of a transmission axis direction of a polarizing plate of the optical device according to the embodiment;

FIG. 9 is an explanatory view showing an example of the transmission axis direction of the polarizing plate of the optical device according to the embodiment;

FIG. 10 is an explanatory view showing an example of the transmission axis direction of the polarizing plate of the optical device according to the embodiment;

FIG. 11 is a chart showing design examples of optic axes of the display apparatus according to the embodiment;

FIG. 12 is an explanatory view for explaining an allowable range of a tilting amount of the transmission axis of the polarizing plate in the optical device according to the embodiment;

FIG. 13 is an explanatory view for explaining an allowable range of the tilting amount of the transmission axis of the polarizing plate in the optical device according to the embodiment;

FIG. 14 is an explanatory view for explaining an allowable range of the tilting amount of the transmission axis of the polarizing plate in the optical device according to the embodiment;

FIG. 15 is a graph showing the relation between a spacer diameter and crosstalk concerning the display apparatus according to the embodiment and a comparative example; and

FIG. 16 is an explanatory view showing a structure of a display apparatus as a comparative example of the display apparatus according to the embodiment.

### DETAILED DESCRIPTION

Hereinafter, preferred embodiments of the present disclosure will be explained in detail with reference to attached drawings. In the present specification and the drawings, components having substantially the same functional structures will be denoted by the same symbols to omit repeated explanation.

The explanation will be made in the following order.

1. Structure of Optical Device

2. Structure of Display Apparatus

3. Configuration of Electronic Apparatus

4. Transmission Axis Direction of Polarizing Plate

5. Example of Effect

### <1. Structure of Optical Device>

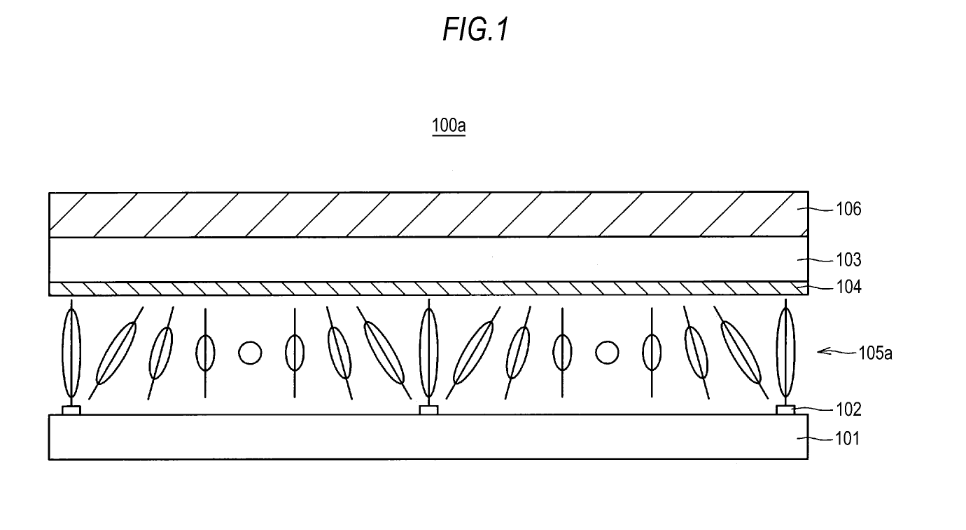

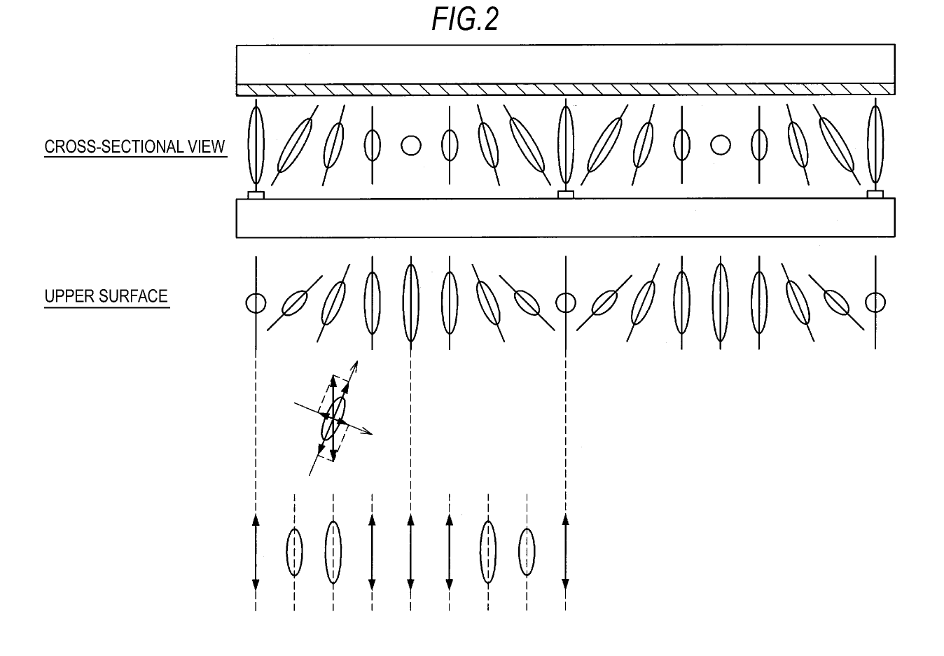

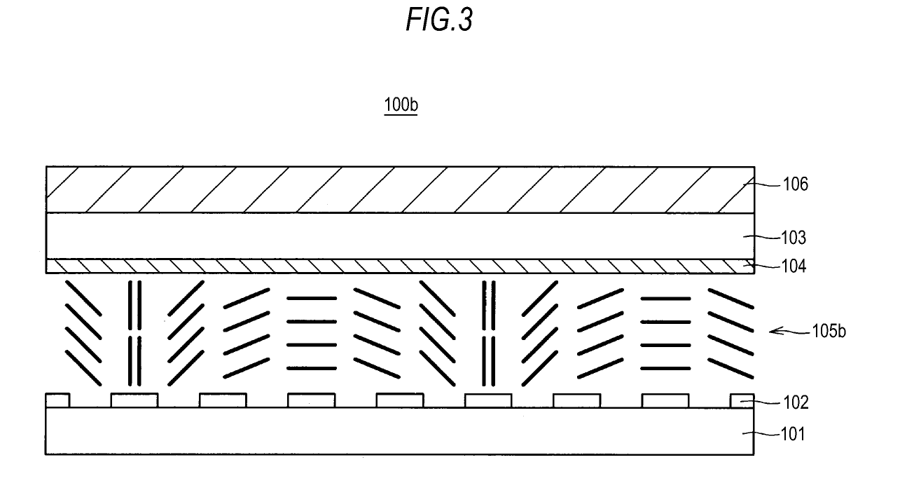

First, a structure of an optical device according to an embodiment of the present disclosure will be explained with reference to FIG. 1 to FIG. 3. FIG. 1 is an explanatory view showing a structure of the optical device according to the embodiment of the present disclosure. FIG. 2 is an explanatory view showing a phenomenon occurring in a liquid crystal lens. FIG. 3 is an explanatory view showing a modification example of the structure of the optical device according to the embodiment of the present disclosure.

Referring to FIG. 1, an optical device 100a according to the embodiment of the present disclosure mainly includes a first substrate 101, a first electrodes 102, a second substrate 103, a second electrode 104, a liquid crystal layer 105a and a polarizing plate 106.

The first substrate 101 and the second substrate 103 are made of a material having transparency with respect to incident light. For example, the first substrate 101 and the second substrate 103 may be made of a glass material. Plural first electrodes 102 are formed on the first substrate 101. The first electrodes 102 are arranged at intervals from one another. The second electrode 104 is formed uniformly on approximately the entire surface of the second substrate 103. The first electrodes 102 and the second electrode 104 are conductive films having transparency with respect to incident light. For example, an ITO (Indium Tin Oxide) film can be cited as an example of the conductive film transparent to visible light.

The liquid crystal layer 105a is formed between the first electrodes 102 and the second electrode 104. The liquid crystal layer 105a includes liquid crystal molecules having refractive index anisotropy. The liquid crystal molecules have different refractive indexes with respect to incident light, for example, in a long-side direction and a short-side direction. The alignment of liquid crystal molecules is changed in accordance with an electric field distribution generated by a voltage to be applied to the first electrodes 102 and the second electrode 104. Accordingly, the refractive index of the liquid crystal layer 105a in appearance with respect to incident light is changed. Therefore, the liquid crystal layer 105a forms a refractive index distribution in accordance with the electric field distribution between the first electrodes 102 and the second electrode 104, which can produce a lens effect. That is, the first substrate 101, the first electrodes 102, the second substrate 103, the second electrode 104 and the liquid crystal layer 105a configure the liquid crystal lens.

In the optical device 100a according to the embodiment, the polarizing plate 106 is arranged on the outermost surface of the optical device 100a. The polarizing plate 106 is a polarizer selectively transmitting light polarized in a particular direction. As described above, the liquid crystal layer 105a can produce the lens effect by forming the refractive index distribution. The lens effect acts on incident light in the particular polarization direction. Accordingly, the effect is used so that light having the particular polarization direction is incident on the optical device 100a. However, there is a case where the liquid crystal layer 105a does not produce the lens effect with respect to certain light due to, for example, depolarization in linear polarization of incident light in spacer (not shown) portions used for securing the thickness of the liquid crystal layer, an alignment defect of liquid crystal on electrodes and so on as shown in FIG. 2. In such case, unnecessary light other than light refracted by the lens effect as requested is included in emitted light emitted from the liquid crystal layer 105a. Accordingly, the optical device 100a according to the embodiment has the polarizing plate 106 on the outermost surface of the liquid crystal lens. The details of the polarizing plate 106 in a transmission axis direction will be explained later.

The method of arranging liquid crystal molecules for producing the lens effect is not limited to the example shown in FIG. 1. For example, an optical device 100b as a modification example of the optical device 100a according to the embodiment is shown in FIG. 3. The optical device 100b mainly includes the first substrate 101, the first electrodes 102, the second substrate 103, the second electrode 104, a liquid crystal layer 105b and the polarizing plate 106. Here, the liquid crystal layer 105b of the optical device 100b has different alignment directions of liquid crystal molecules as compared with the liquid crystal layer 105a of the optical device 100a. The technology of the present disclosure can be applied to this type of liquid crystal lens.

### <2. Structure of Display Apparatus>

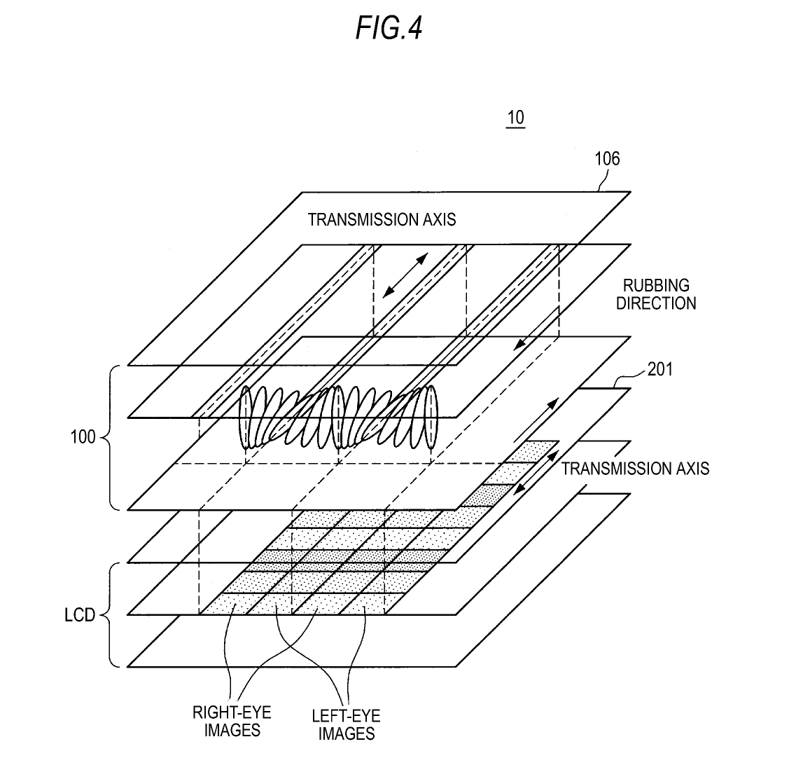

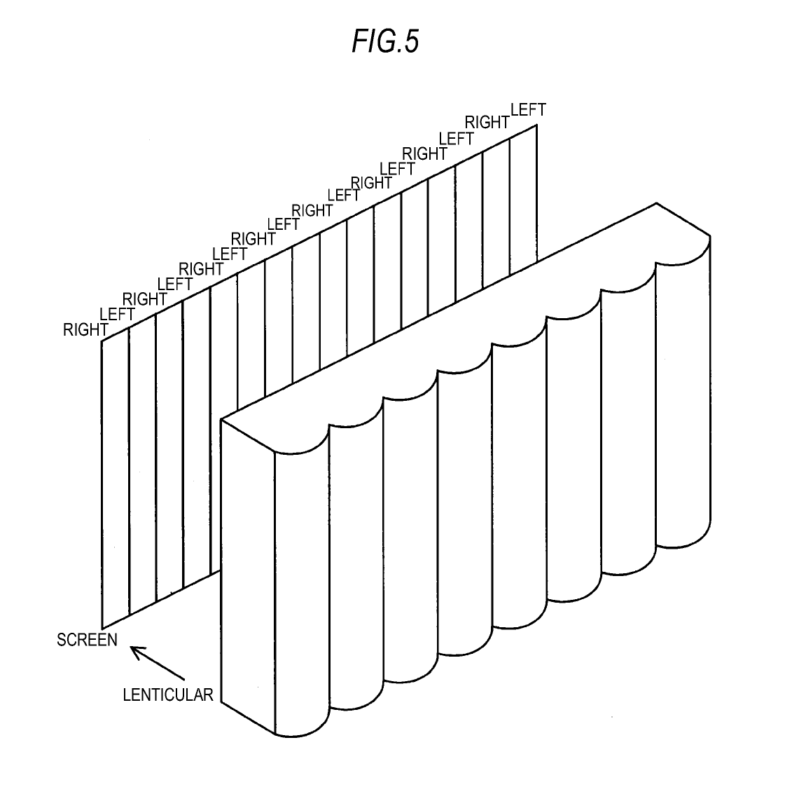

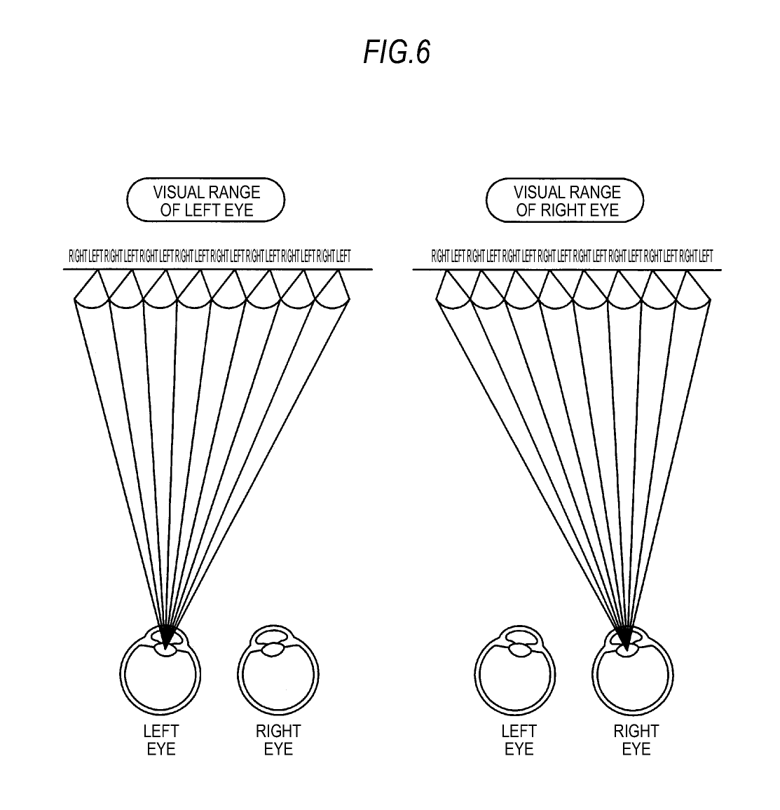

Next, a display apparatus using the optical device according to the embodiment of the present disclosure will be explained with reference to FIG. 4 to FIG. 6. FIG. 4 is an explanatory view showing a structure of the display apparatus using the optical device according to the embodiment. FIG. 5 is an explanatory view showing an example of an appearance of a lenticular lens and a screen structure. FIG. 6 is an explanatory view showing the principle of the lenticular lens.

The display apparatus 10 includes a LCD (Liquid Crystal Display) and an optical device 100 arranged so as to face the LCD. The optical device 100 refracts incident light as image light of the LCD to respectively form images at desired positions. The LCD can display an image for stereoscopic display. The image for stereoscopic display is configured by alternately arranging right-eye images and left-eye images.

Here, the optical device 100 produces the lenticular-type lens effect. The principle of the lenticular lens will be explained with reference to FIG. 5 and FIG. 6. The lenticular lens is a lens in which semi-cylindrical shapes are connected as shown in FIG. 5. When two pictures including binocular parallax are alternately arranged line by line on one screen behind the lenticular lens and are observed from a particular distance, the observer can recognize the images as a stereoscopic picture. The lenticular lens functions as a prism changing positions where sight lines reach the screen. The lenticular lens also functions as a convex lens enlarging the image of one line by adjusting a focus of the lens on the screen.

Accordingly, left-eye images are enlarged over the entire range of the lens to be provided to the left eye, and right-eye images are enlarged over the entire range of the lens to be provided to the right eye as shown in FIG. 6. As parallax is included in the left-eye images and the right-eye images, the observer can recognize the image as a stereoscopic image.

As the optical device 100 has the lenticular-type lens effect, the optical device 100 can separate the image for stereoscopic display displayed by the LCD into right-eye images and left-eye images to be provided to the observer.

In this case, the optical device 100 has the polarizing plate 106 on the outermost surface, namely, at a position closer to the observer than the liquid crystal layer 105. A polarizing plate for controlling the polarization direction of light to be incident on the optical device 100 is provided at a position closer to the observer in the LCD. However, there is a case where the liquid crystal layer 105 does not produce the lens effect with respect to certain light due to depolarization in spacer portions, an alignment defect of liquid crystal on electrodes and so on as described above. The polarizing plate 106 can reduce unnecessary light generated in such case to be included in light emitted from the optical device 100. When unnecessary light is included in light emitted from the optical device 100, the crosstalk is increased. Therefore, the effect of reducing the crosstalk can be expected by applying the optical device 100 including the polarizing plate 106 to the display apparatus 10 supporting stereoscopic display. A rubbing direction, the transmission axis direction and the like shown in FIG. 4 are examples, which will be explained in detail later.

### <3. Configuration of Electronic Apparatus>

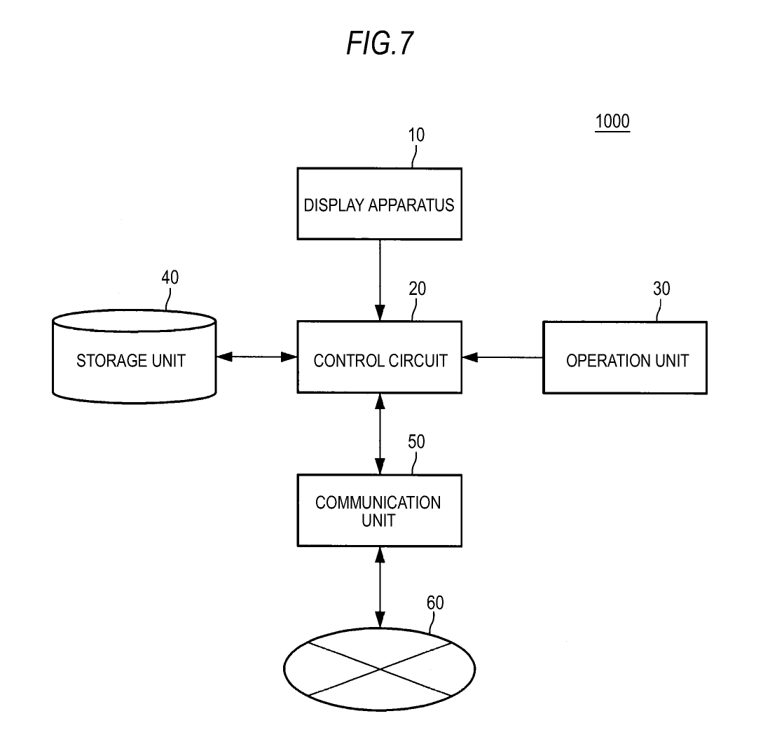

Here, a configuration example of an electronic apparatus using the display apparatus including the above optical device according to the embodiment of the present disclosure will be explained with reference to FIG. 7. FIG. 7 is a block diagram showing a configuration example of the electronic apparatus using the display apparatus including the optical device according to the embodiment of the present disclosure.

Referring to FIG. 7, an electronic apparatus 1000 includes the display apparatus 10, a control circuit 20, an operation unit 30, a storage unit 40 and a communication unit 50. The electronic apparatus 1000 is, for example, some kind of apparatus using the liquid crystal lens in a display unit such as a television, a cellular phone (smart phone), a digital camera, a personal computer, a navigation apparatus or a game machine.

The control circuit 20 includes, for example, a CPU (Central Processing Unit), a RAM (Random Access Memory) and a ROM (Read Only Memory) and the like, controlling respective units of the electronic apparatus 1000. The display apparatus 10 is also controlled by the control circuit 20.

The operation unit 30 includes, for example, a touch pad, buttons, a keyboard, a mouse and so on, receiving operation input by a user with respect to the electronic apparatus 1000. The control circuit 20 controls the electronic apparatus 1000 in accordance with operation input acquired by the operation unit 30.

The storage unit 40 includes, for example, a semiconductor memory, a magnetic disc, an optical disc and so on, storing various types of data necessary for allowing the electronic apparatus 1000 to function. The control circuit 20 may operate by reading and executing programs stored in the storage unit 40.

The communication unit 50 is additionally provided. The communication unit 50 is a communication interface connected to a wired or wireless network 60 including, for example, a modem, a port, an antenna and the like. The control circuit 20 receives data from the network 60 or transmits data to the network 60 through the communication unit 50.

Not only the optical device 100 and the display apparatus 10 but also the electronic apparatus 1000 having the display apparatus 10 are included in the embodiment of the present disclosure.

### <4. Transmission Axis Direction of Polarizing Plate>

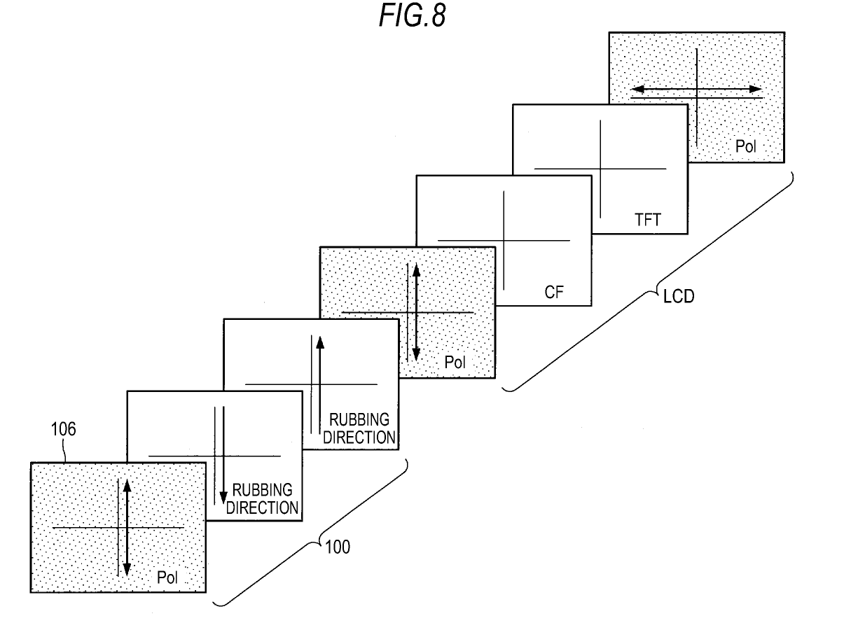

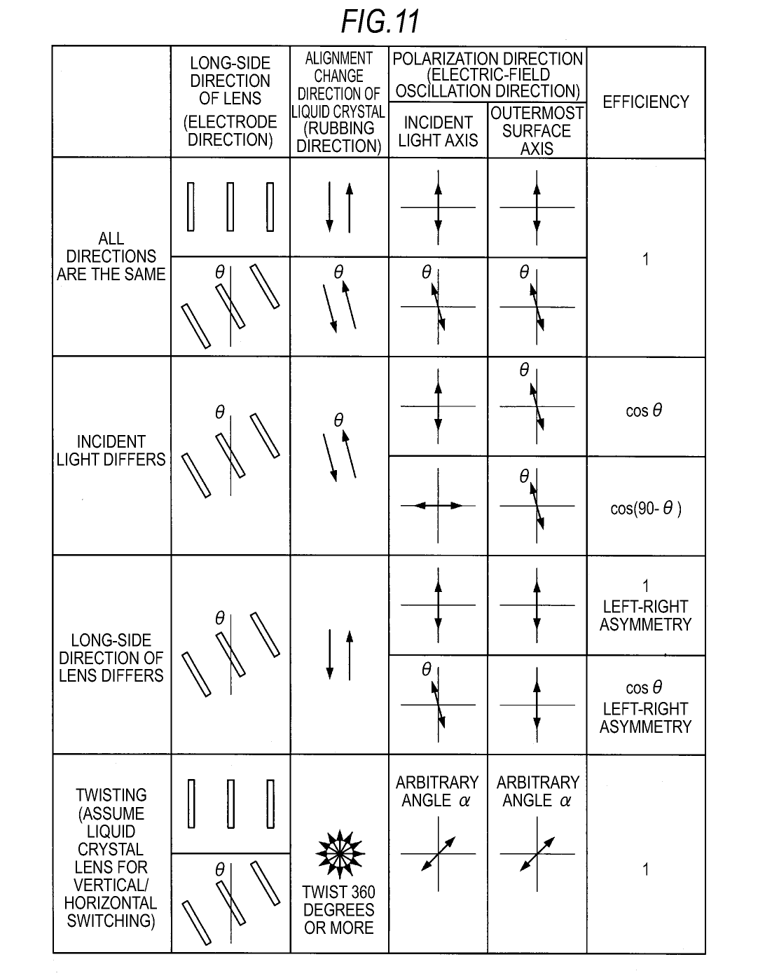

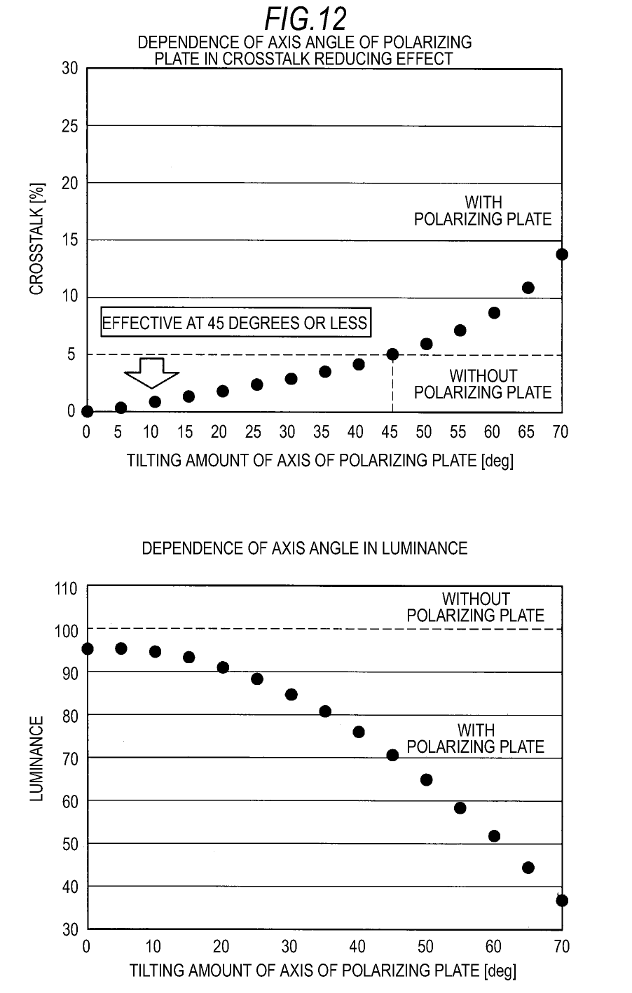

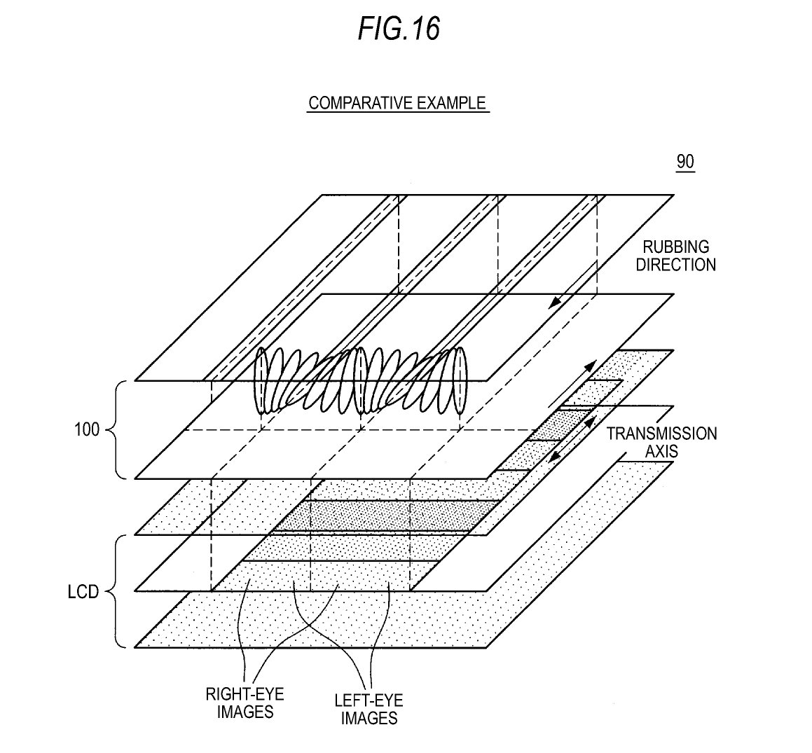

Next, a transmission axis direction of the polarizing plate arranged on the outermost surface of the optical device according to the embodiment of the present disclosure will be explained with reference to FIG. 8 to FIG. 14 and FIG. 16. FIG. 8 to FIG. 10 are explanatory views showing examples of the transmission axis direction of the polarizing plate of the optical device according to the embodiment. FIG. 11 is a chart showing design examples of optic axes of the display apparatus according to the embodiment. FIG. 12 to FIG. 14 are explanatory views for explaining an allowable range of a tilting amount of the transmission axis of the polarizing plate in the optical device according to the embodiment. FIG. 16 is an explanatory view showing a structure of a display apparatus as a comparative example of the display apparatus according to the embodiment.

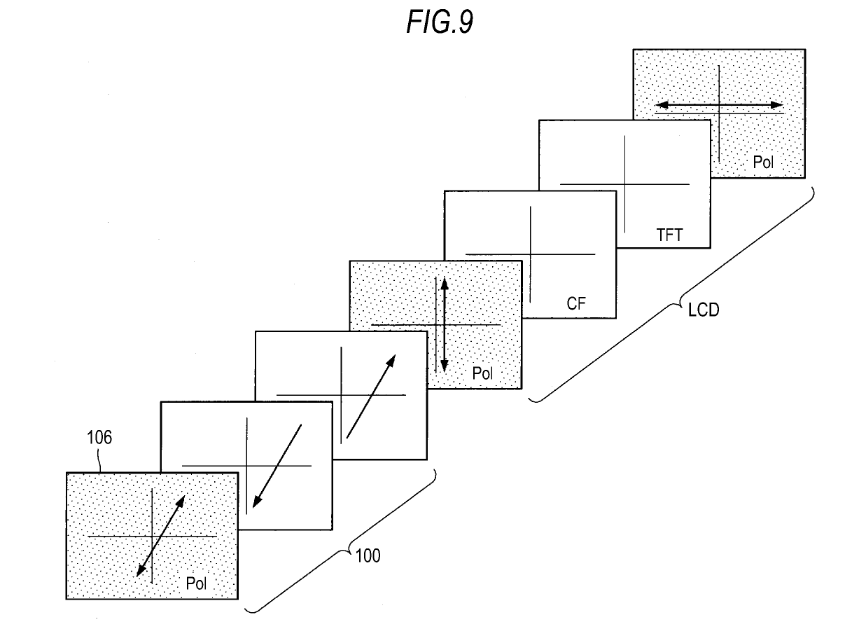

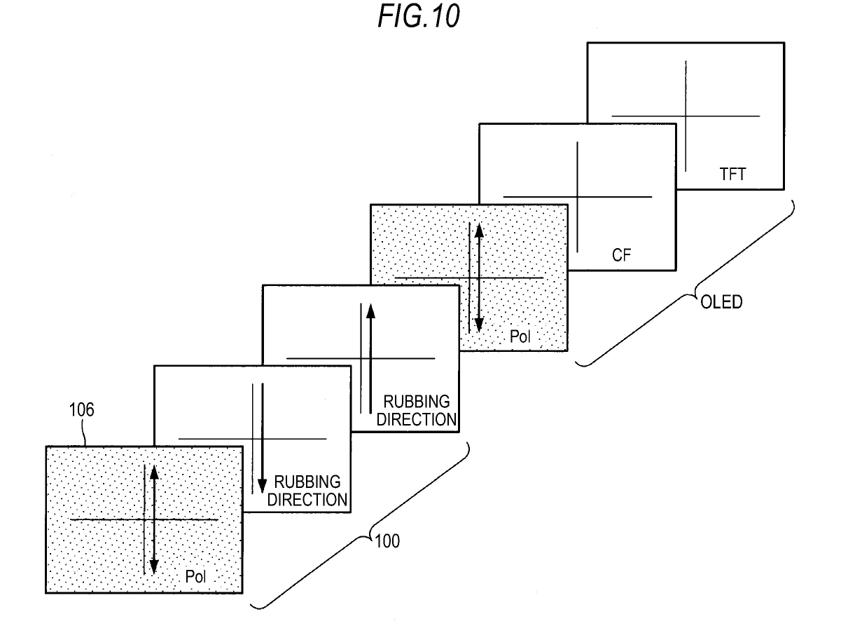

First, an example of respective axis directions of the display apparatus using the LCD is shown in FIG. 8. A case where a polarization direction of incident light, a rubbing direction as an alignment change direction of liquid crystal and a polarization direction of the polarizing plate 106 (Pol) arranged on the outer surface are all the same is shown here as an example. FIG. 9 shows another example of respective axis directions of the display apparatus using the LCD. In this case, the polarization direction of incident light does not correspond to the rubbing direction as the alignment change direction of liquid crystal. It is desirable in this case that the transmission axis direction of the polarizing plate 106 corresponds to the rubbing direction, namely, a direction in which the lens effect of the liquid crystal lens is produced. It is also possible to apply the technology of the present disclosure to an OLED (Organic Light-Emitting Display) as shown in FIG. 10. Also in this case, the transmission axis direction of the polarizing plate 106 is arranged so as to correspond to the rubbing direction in the same manner as the above.

Here, FIG. 11 shows design examples of the optic axes in respective axis directions of the display apparatus according to the embodiment and efficiency in respective cases. In all cases, the direction of an outermost surface axis, namely, the transmission axis direction of the polarizing plate 106 will be a direction corresponding to the alignment change direction of liquid crystal (rubbing direction), namely, the direction in which the lens effect of the liquid crystal lens is produced. In this chart, a long-side direction of a lens (electrode direction), the alignment change direction of liquid crystal (rubbing direction), the polarization direction of incident light onto the optical device 100, the polarization direction on the outermost surface (namely, the transmission axis direction of the polarizing plate 106) and efficiency are shown. Here, the efficiency obtained when the long-side direction of the lens (electrode direction), the alignment change direction of liquid crystal (rubbing direction), the polarization direction of incident light, the polarization direction on the outermost surface (namely, the transmission axis direction of the polarizing plate 106) are all the same is “1” (maximum). In a case where the polarization direction of incident light onto the operation device 100 differs, the efficiency is represented by “cos θ” when an angle made by the polarization direction of incident light and another axis is θ. In a case where the long-side direction of the lens differs and the alignment change direction of liquid crystal (rubbing direction), the polarization direction of incident light and the polarization direction on the outermost surface (namely, the transmission axis direction of the polarizing plate 106) are the same, the efficiency is “1”. In a case where the alignment change direction of liquid crystal is twisted 360 degrees or more in a liquid crystal lens for vertical/horizontal switching, the polarization directions of the incident-light axis and the outermost surface axis have an arbitrary angle α and the efficiency is “1”.

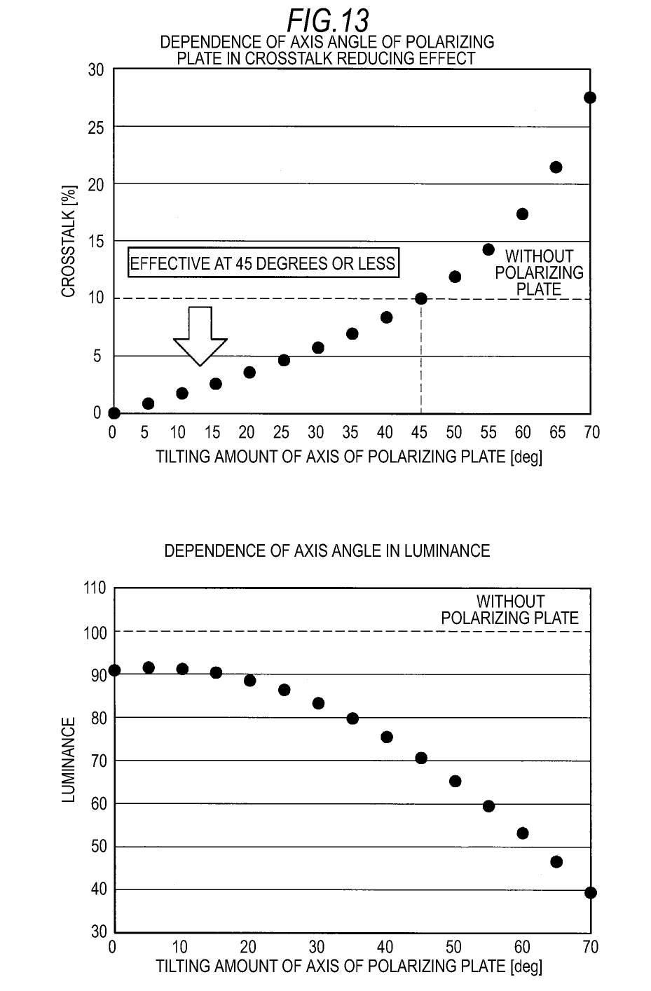

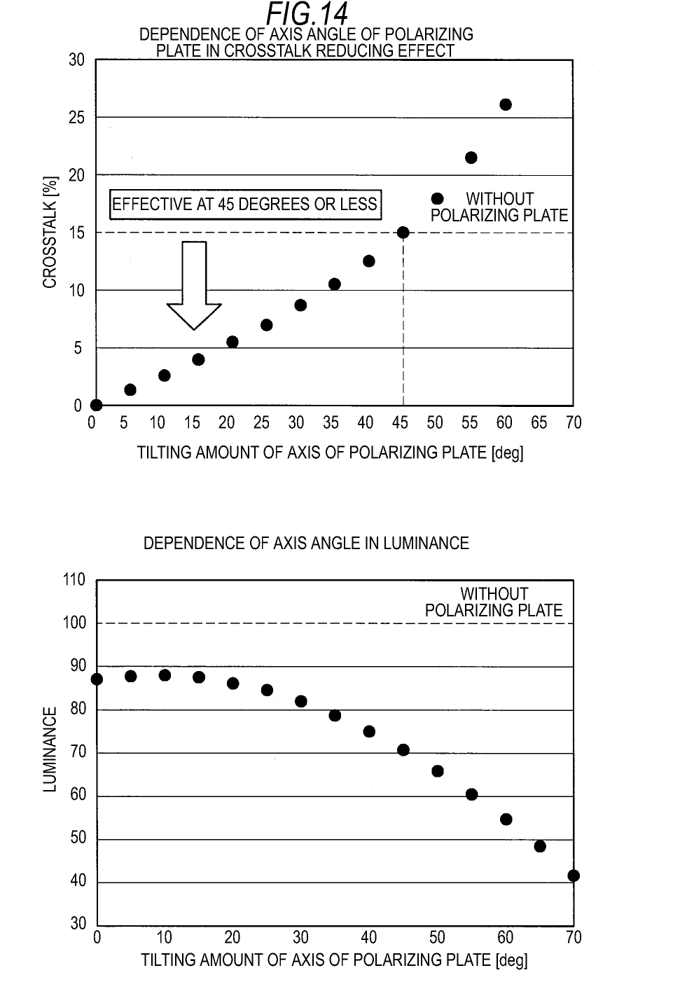

An allowable range of an angle made by the direction in which the lens effect of the liquid crystal lens is produced and the transmission axis direction of the polarizing plate 106 will be considered as follows with reference to FIG. 12 to FIG. 14 and FIG. 16. FIG. 12 shows dependences of the transmission axis angle of the polarizing plate in crosstalk reducing effect and in luminance after transmitting the polarizing plate 106 when the crosstalk is 5% in a structure of a comparative example 90 in which the polarizing plate 106 is not arranged. Additionally, the dependences of the transmission axis angle of the polarizing plate in crosstalk reducing effect and in luminance when the crosstalk is 10% in the structure of the comparative example 90 in which the polarizing plate 106 is not arranged are shown in FIG. 13 as well as the dependences of the same when the crosstalk is 15% in the structure of the comparative example 90 in which the polarizing plate 106 is not arranged are shown in FIG. 14. Here, the structure of the comparative example 90 is explained with reference to FIG. 16. A display apparatus of the comparative example 90 differs from the display apparatus 10 in a point that the polarizing plate 106 on the outermost surface is not included.

It is found from these drawings that the crosstalk can be reduced as compared with a structure in which the polarizing plate 106 is not provided when the tilting amount of the transmission axis of the polarizing plate 106 with respect to the optimum axis direction, namely, the direction in which the lens effect of the liquid crystal lens is produced is within +−45 degrees. It is also found from these drawings that the crosstalk can be reduced to ⅓ when the tilting amount of the transmission axis with respect to the optimum axis direction is within +−20 degrees. The luminance is attenuated with respect to the transmission axis of the polarization plate at the cos θ. Accordingly, the tilting amount of the transmission axis of the polarizing plate 106 may be +−26 degrees or less with respect to the optimum axis direction in order to suppress luminance reduction within 10% from the luminance obtained in the optimum axis direction.

According to the above, it is desirable that the angle made by the direction in which the lens effect of the liquid crystal lens is produced and the transmission axis of the polarizing plate 106 is 45 degrees or less. It is further desirable that the angle made by the direction in which the lens effect of the liquid crystal lens is produced and the transmission axis of the polarizing plate 106 is 26 degrees or less. It is furthermore desirable that the angle made by the direction in which the lens effect of the liquid crystal lens is produced and the transmission axis of the polarizing plate 106 is 20 degrees or less.

### <5. Example of Effect>

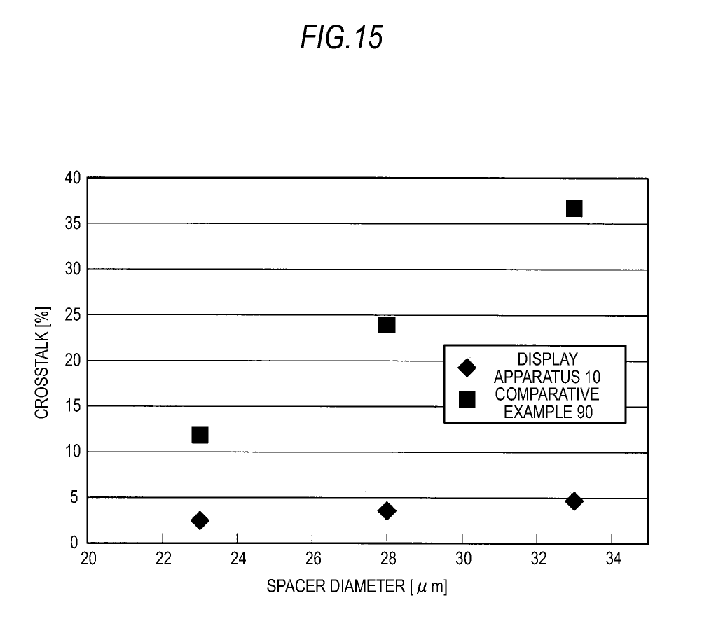

The effect of reducing the crosstalk obtained when the optical device according to the embodiment is used will be further considered with reference to FIG. 15. FIG. 15 is a graph showing the relation between a spacer diameter and crosstalk concerning the display apparatus according to the embodiment and the comparative example.

The comparative example 90 shown in FIG. 15 is data concerning the display apparatus as the comparative example 90 described with reference to FIG. 16. Assume that the direction in which the lens effect of the liquid crystal lens is produced is set so as to approximately correspond to the transmission axis of the polarizing plate 106 in the display apparatus 10 in this case. The value of the crosstalk largely differs in accordance with the spacer diameter as shown in the graph, however, it is found that the crosstalk is drastically reduced by using the optical device 100 having the polarizing plate 106 on the outermost surface in every case.

As described above, as unnecessary components included in light emitted from the liquid crystal lens can be eliminated by using the optical device 100 having the polarizing plate 106 on the outermost surface of the liquid crystal lens, the crosstalk can be reduced. The effect of reducing the crosstalk is increased as the degree in which the transmission axis direction of the polarizing plate 106 corresponds to the direction in which the lens effect of the liquid crystal lens is produced becomes high. However, the effect of reducing the crosstalk can be obtained when the angle made by the transmission axis direction of the polarizing plate 106 and the direction in which the lens effect of the liquid crystal lens is produced is 45 degrees or less. More preferably, the crosstalk can be reduced to ⅓ when the angle made by the transmission axis direction of the polarizing plate 106 and the direction in which the lens effect of the liquid crystal lens is produced is 26 degrees or less. Furthermore preferably, the effect of reducing crosstalk can be obtained while suppressing the luminance reduction to 10% or less when the angle made by the transmission axis direction of the polarizing plate 106 and the direction in which the lens effect of the liquid crystal lens is produced is 20 degrees or less.

The preferred embodiments of the present disclosure have been explained in detail as the above with reference to the attached drawings, however, the technical range of the present disclosure is not limited to the above example. It is obvious that various modifications or alterations may occur to those skilled in the art of the present disclosure within the scope of technical ideas described in the appended claims, which naturally belong to a technical range of the present disclosure.

In the drawings and the above explanation, points necessary for understanding the technical contents of the present disclosure are chiefly shown. Accordingly, not all the structures are shown in the drawings. Structures other than the structures shown in the drawings may be included. Additionally, the thickness or the size of components shown in the drawings is not necessarily drawn with precise proportion.

Furthermore, the display apparatus using the liquid crystal lens is the 3D display apparatus in the above embodiment, however, the application range of the present disclosure is not limited to the example. For example, the display apparatus using the liquid crystal lens is not limited to the 3D display apparatus and may be applied to all display apparatuses separating the image into plural viewpoint images to be provided. The 3D display apparatus provides two images respectively to the right and left eyes of one observer to thereby allow the observer to recognize the images as a 3D image. The divided images may be provided to plural observers. According to the above display apparatus, different images can be respectively provided to plural observers. This kind of display apparatus may be applied to a navigation apparatus. The navigation apparatus can provide different images respectively to an observer sitting in a driver's seat and an observer sitting in a passenger's seat.

The following configurations also belong to a technical range of the present disclosure.

(1) An optical device including

first electrodes,

a second electrode arranged so as to face the first electrodes,

a liquid crystal layer arranged between the first electrodes and the second electrode, producing a lens effect in accordance with a voltage to be applied to the first electrodes and the second electrode, and

a polarizing plate arranged on an outermost surface.

(2) The optical device described in the above (1),

in which an angle made by a polarization direction in which the lens effect is produced and a transmission axis of the polarizing plate is 45 degrees or less.

(3) The optical device described in the above (1) or (2),

in which the angle made by the polarization direction in which the lens effect is produced and the transmission axis of the polarizing plate is 26 degrees or less.

(4) The optical device described in any of the above (1) to (3),

in which the angle made by the polarization direction in which the lens effect is produced and the transmission axis of the polarizing plate is 20 degrees or less.

(5) The optical device described in any of the above (1) to (4),

in which the lens effect of the liquid crystal layer is equivalent to a lenticular lens.

(6) A display apparatus including

a display unit emitting image light polarized in a particular polarization direction,

a liquid crystal lens arranged so as to face the display unit and forming images of the image light emitted by the display unit in plural viewpoints, and

a polarizing plate arranged on the liquid crystal lens.

(7) An electronic apparatus including

a display unit emitting image light polarized in a particular polarization direction,

a liquid crystal lens arranged so as to face the display unit and forming images of the image light emitted by the display unit in plural viewpoints, and

a polarizing plate arranged on the liquid crystal lens.

The present disclosure contains subject matter related to that disclosed in Japanese Priority Patent Application JP 2012-051827 filed in the Japan Patent Office on Mar. 8, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical device comprising:
first electrodes;
a second electrode arranged so as to face the first electrodes;
a liquid crystal layer arranged between the first electrodes and the second electrode, producing a lens effect in accordance with a voltage to be applied to the first electrodes and the second electrode; and
a polarizing plate arranged on an outermost surface.

2. The optical device according to claim 1,
wherein an angle made by a polarization direction in which the lens effect is produced and a transmission axis of the polarizing plate is 45 degrees or less.

3. The optical device according to claim 1,
wherein an angle made by a polarization direction in which the lens effect is produced and a transmission axis of the polarizing plate is 26 degrees or less.

4. The optical device according to claim 1,
wherein an angle made by a polarization direction in which the lens effect is produced and a transmission axis of the polarizing plate is 20 degrees or less.

5. The optical device according to claim 1,
wherein the lens effect of the liquid crystal layer is equivalent to a lenticular lens.

6. A display apparatus comprising:
a display unit emitting image light polarized in a particular polarization direction;
a liquid crystal lens arranged so as to face the display unit and forming images of the image light emitted by the display unit in plural viewpoints; and
a polarizing plate arranged on the liquid crystal lens.

7. An electronic apparatus comprising:
a display unit emitting image light polarized in a particular polarization direction;
a liquid crystal lens arranged so as to face the display unit and forming images of the image light emitted by the display unit in plural viewpoints; and
a polarizing plate arranged on the liquid crystal lens.
